(19) United States
(12) Patent Application Publication
(10) Pub. No.: US 2008/0221353 A1
(43) Pub. Date: Sep. 11, 2008

(54) Novel phosphonium salt ionic liquid and reaction solvent including the same

(75) Inventor: Katsuhiko Tsunashima, Tokyo (JP)

Correspondence Address: Edwards Angell Palmer & Dodge LLP, P.O. Box 55874, Boston, MA, 02205, US

(73) Assignee: Nippon Chemical Industrial Co., Ltd., Tokyo (JP)

(21) Appl. No.: 12/073,426

(22) Filed: Mar. 5, 2008

(30) Foreign Application Priority Data
Mar. 9, 2007 (JP) 2007-60207

(51) Int. Cl. C07F 9/06

(52) U.S. Cl. 564/12; 564/15

(57) ABSTRACT

The present invention provides an ionic liquid including a quaternary phosphonium salt represented by general formula (1):

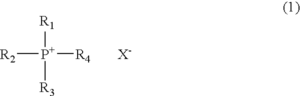

wherein R₁, R₂, R₃, and R₄ each represent a linear alkyl group having 1 to 6 carbon atoms, a branched alkyl group having 3 to 6 carbon atoms, an alicyclic alkyl group having 3 to 6 carbon atoms, or an alkoxyalkyl group represented by —(CH₂)ₙO—R₅ (wherein n is an integer of 1 to 6; and R₅ represents a methyl group or an ethyl group); at least one of R₁, R₂, R₃, and R₄ is an alkoxyalkyl group; R₁, R₂, R₃, and R₄ may be the same or different; R₁ and R₂ together may form a ring; and X represents an anion. The present invention also provides a reaction solvent including the ionic liquid.

### BACKGROUND OF THE INVENTION

1. Field of the Invention

The present invention relates to an ionic liquid including a specific quaternary phosphonium salt, and a reaction solvent including the ionic liquid.

2. Description of the Related Art

In recent years, research has been conducted on ionic liquids as environmentally friendly reaction solvents. The term “ionic liquid” refers to a salt which is generally stable in air and which is liquid at normal temperature and pressure. In many cases, ionic liquids have almost zero vapor pressure and have flame retardancy. Originally, ionic liquids were studied as electrolytes in the electrochemical field. By taking advantage of such properties, ionic liquids have also been used as reaction solvents and receiving attention as environmentally friendly solvents and reusable solvents.

As ionic liquids, in addition to imidazolium salts and pyridinium salts, some ammonium salts and phosphonium salts are also known. For example, Japanese Unexamined Patent Application Publication No. 2004-111294 (Patent Document 1) describes, in the claims, nonaqueous electrolytes each containing an ionic liquid which is composed of a quaternary ammonium salt or phosphonium salt, wherein at least one of alkyl groups bonded to a nitrogen atom or phosphorus atom is an alkoxyalkyl group.

However, in Patent Document 1, only ammonium salts are shown as examples. As a result of the present inventor's study, as will be described later, it has been found that, since the acidity of the hydrogen atom adjacent to the ammonium cation is high compared with that of the hydrogen atom adjacent to the phosphonium cation, for example, in a reaction where a highly basic reagent, such as a Grignard reagent, is used, ammonium salts react with the reagent, resulting in a decrease in yield.

Furthermore, International Publication No. WO2006/007703 (Patent Document 2), on page 7 and in FIG. 4, and The Royal Society of Chemistry 2005, 325-327 (Non-Patent Document 1), on page 326, each describe a reaction solvent including a tetraalkylphosphonium salt and the use thereof in a Grignard reaction. However, it has been suggested that the longer the alkyl group, the more effectively the reaction between the Grignard reagent and the active hydrogen adjacent to the cation is prevented. However, as the alkyl group becomes longer, viscosity increases, and when used as a reaction solvent, diffusion and convection of a reactive substrate are inhibited, resulting in a decrease in the reaction rate. Furthermore, as the viscosity increases, dehydration efficiency decreases, and the water content in the ionic liquid increases. Consequently, such an ionic liquid cannot be used as the solvent for a reaction using a reagent, such as a Grignard reagent, whose activity is decreased by water, which is a problem. Furthermore, as the alkyl group becomes longer, the solubility of organic substances is significantly increased. As a result, a halide which is a starting material for producing the tetraalkylphosphonium salt and a trialkylphosphine oxide formed as a by-product during the production remain as impurities and become difficult to remove. This also decreases the range of choices of extracting solvents which can be used in treatment carried out after the synthesis reaction, which is also a problem. Furthermore, neither Patent Document 2 nor Non-Patent Document 1 describes an alkyl group substituted with a methoxy group or an ethoxy group.

### SUMMARY OF THE INVENTION

It is an object of the present invention to provide an ionic liquid composed of a quaternary phosphonium salt which has low viscosity and does not inhibit diffusion or convection of a reactive substrate, which has significantly low reactivity with a reactive substrate and has a significantly low water content, and which can be used as a reaction solvent for various organic synthesis reactions.

The present inventor has conducted diligent studies and found that an ionic liquid including a specific quaternary phosphonium salt has significantly low viscosity, high resistance to bases, and high heat resistance, and thus can be used as a solvent for organic synthesis reactions. Thereby, the present invention has been completed.

In a first aspect of the present invention, an ionic liquid includes a quaternary phosphonium salt represented by general formula (1):

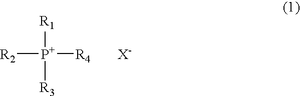

wherein R₁, R₂, R₃, and R₄ each represent a linear alkyl group having 1 to 6 carbon atoms, a branched alkyl group having 3 to 6 carbon atoms, an alicyclic alkyl group having 3 to 6 carbon atoms, or an alkoxyalkyl group represented by —(CH₂)ₙO—R₅ (wherein n is an integer of 1 to 6; and R₅ represents a methyl group or an ethyl group); at least one of R₁, R₂, R₃, and R₄ is an alkoxyalkyl group; R₁, R₂, R₃, and R₄ may be the same or different; R₁ and R₂ together may form a ring; and X represents an anion.

The quaternary phosphonium salt represented by general formula (1) preferably has a viscosity of 300 mPas or less.

Furthermore, in general formula (1), preferably, the number of carbon atoms of each of R₁, R₂, and R₃ is 2, and R₄ is a 2-methoxyethyl group.

In general formula (1), preferably, X is a bis(trifluoromethylsulfonyl)imide anion.

The quaternary phosphonium salt represented by general formula (1) preferably has a water content of 100 ppm or less.

In a second aspect of the present invention, a reaction solvent includes the ionic liquid including a quaternary phosphonium salt represented by general formula (1).

In a third aspect of the present invention, a reaction solvent for a Grignard reaction includes the ionic liquid including a quaternary phosphonium salt represented by general formula (1).

In the ionic liquid according to the present invention, when used as a reaction solvent, diffusion or convection of a reactive substrate is not inhibited because of low viscosity, and reactivity with a reactive substrate is significantly low because of high resistance to bases. Furthermore, heat resistance is high, and the water content is significantly low. Consequently, the ionic liquid can be used as a solvent for various organic synthesis reactions.

### DESCRIPTION OF THE PREFERRED EMBODIMENTS

The present invention will now be described on the basis of preferred embodiments. An ionic liquid of the present invention includes a quaternary phosphonium salt represented by general formula (1):

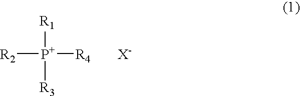

wherein R₁, R₂, R₃, and R₄ each represent a linear alkyl group having 1 to 6 carbon atoms, a branched alkyl group having 3 to 6 carbon atoms, an alicyclic alkyl group having 3 to 6 carbon atoms, or an alkoxyalkyl group represented by —(CH₂)ₙO—R₅; R₁, R₂, R₃, and R₄ may be the same or different; R₁ and R₂ together may form a ring; at least one of R₁, R₂, R₃, and R₄ is an alkoxyalkyl group; in the alkoxyalkyl group, n is an integer of 1 to 6, and R₅ represents a methyl group or an ethyl group; and X represents an anion.

Specific examples of the alkyl group represented by each of R₁ to R₄ in general formula (1) include a methyl group, an ethyl group, a n-propyl group, a n-butyl group, a n-hexyl group, an i-propyl group, an i-butyl group, a n-pentyl group, a cyclopentyl group, and a cyclohexyl group. Specific examples of the alkoxyalkyl group include a methoxymethyl group, a 2-methoxyethyl group, a 3-methoxypropyl group, a 4-methoxybutyl group, a 5-methoxypentyl group, a 6-methoxyhexyl group, an ethoxymethyl group, a 2-ethoxyethyl group, a 3-ethoxypropyl group, a 4-ethoxybutyl group, a 5-ethoxypentyl group, and a 6-ethoxyhexyl group.

The anion component represented by X in general formula (1) is not particularly limited as long as it is a liquid at a temperature at which the ionic liquid is used as a reaction solvent. Examples thereof include tetrafluoroborate (BF₄), hexafluorophosphate (PF₆), bis(trifluoromethylsulfonyl)imide (N(SO₂CF₃)₂), bis(fluorosulfonyl)imide (N(SO₂F)₂), trifluoromethanesulfonate (SO₃CF₃), methanesulfonate (SO₃CH₃), tris(pentafluoroethyl)trifluorophosphate ((C₂H₅)₃PF₃), trifluoroacetic acid (CF₃COO), amino acid, bisoxalatoborate (B(C₂O₄)₂), p-toluenesulfonate (SO₃C₆H₄CH₃), thiocyanate (SCN), dicyanamide (N(CN)₂), halogen, dialkyl phosphoric acid ((RO)₂POO), dialkyl dithiophosphoric acid ((RO)₂PSS), and aliphatic carboxylic acid (RCOO). Among them, bis(trifluoromethylsulfonyl)imide and dicyanamide are preferable in view of their low viscosity.

Specific examples of the quaternary phosphonium salt represented by general formula (1) include triethyl(methoxymethyl)phosphonium bis(trifluoromethylsulfonyl)imide, triethyl(methoxymethyl)phosphonium tetrafluoroborate, triethyl(methoxymethyl)phosphonium hexafluorophosphate, triethyl(methoxymethyl)phosphonium trifluoromethanesulfonate, triethyl(methoxymethyl)phosphonium bis(fluorosulfonyl)imide, triethyl(methoxymethyl)phosphonium thiocyanate, triethyl(methoxymethyl)phosphonium dicyanamide, triethyl(methoxymethyl)phosphonium dialkyl phosphoric acid, triethyl(2-methoxyethyl)phosphonium bis(trifluoromethylsulfonyl)imide, triethyl(methoxymethyl)phosphonium tetrafluoroborate, triethyl(2-methoxyethyl)phosphonium tetrafluoroborate, triethyl(2-methoxyethyl)phosphonium hexafluorophosphate, triethyl(2-methoxyethyl)phosphonium trifluoromethanesulfonate, triethyl(2-methoxyethyl)phosphonium bis(fluorosulfonyl)imide, triethyl(2-methoxyethyl)phosphonium thiocyanate, triethyl(2-methoxyethyl)phosphonium dicyanamide, triethyl(2-methoxyethyl)phosphonium dialkyl phosphoric acid, diethylmethyl(methoxymethyl)phosphonium bis(trifluoromethylsulfonyl)imide, diethylmethyl(methoxymethyl)phosphonium tetrafluoroborate, diethylmethyl(methoxymethyl)phosphonium dicyanamide, diethylmethyl(2-methoxyethyl)phosphonium bis(trifluoromethylsulfonyl)imide, diethylmethyl(2-methoxyethyl)phosphonium tetrafluoroborate, diethylmethyl(2-methoxyethyl)phosphonium dicyanamide, tri-n-propyl(methoxymethyl)phosphonium bis(trifluoromethylsulfonyl)imide, tri-n-propyl(2-methoxyethyl)phosphonium bis(trifluoromethylsulfonyl)imide, tri-n-butyl(methoxymethyl)phosphonium bis(trifluoromethylsulfonyl)imide, tri-n-butyl(methoxymethyl)phosphonium tetrafluoroborate, tri-n-butyl(methoxymethyl)phosphonium dicyanamide, tri-n-butyl(2-methoxyethyl)phosphonium bis(trifluoromethylsulfonyl)imide, tri-n-butyl(2-methoxyethyl)phosphonium tetrafluoroborate, tri-n-butyl(2-methoxyethyl)phosphonium dicyanamide, tri-n-pentyl(methoxymethyl)phosphonium bis(trifluoromethylsulfonyl)imide, tri-n-pentyl(2-methoxymethyl)phosphonium bis(trifluoromethylsulfonyl)imide, tri-n-hexyl(methoxymethyl)phosphonium bis(trifluoromethylsulfonyl)imide, and tri-n-hexyl(2-methoxyethyl)phosphonium bis(trifluoromethylsulfonyl)imide. Among them, triethyl(methoxymethyl)phosphonium bis(trifluoromethylsulfonyl)imide, triethyl(methoxymethyl)phosphonium tetrafluoroborate, triethyl(methoxymethyl)phosphonium dicyanamide, triethyl(2-methoxyethyl)phosphonium bis(trifluoromethylsulfonyl)imide, triethyl(2-methoxyethyl)phosphonium tetrafluoroborate, triethyl(2-methoxyethyl)phosphonium dicyanamide, tri-n-butyl(methoxymethyl)phosphonium bis(trifluoromethylsulfonyl)imide, and tri-n-butyl(2-methoxyethyl)phosphonium bis(trifluoromethylsulfonyl)imide are preferable in view of low viscosity, resistance to bases, and heat resistance. Furthermore, among them, triethyl(methoxymethyl)phosphonium bis(trifluoromethylsulfonyl)imide and triethyl(2-methoxyethyl)phosphonium bis(trifluoromethylsulfonyl)imide are more preferable in view of the large range of choices of extracting solvents.

The ionic liquid including a quaternary phosphonium salt according to the present invention has a viscosity of 300 mPas or less, preferably 100 mPas or less, and more preferably 60 mPas or less. A viscosity of 300 mPas or less is preferable in view of reaction efficiency and dehydration efficiency. If the viscosity is 100 mPas or less, the rate of the increase in viscosity due to cooling is low, and the ionic liquid can be used for an organic synthesis reaction at low temperatures, thus being preferable. Furthermore, purification efficiency due to solvent washing is high, and the remaining halide, metal, and alkylphosphine oxide can be removed efficiently, thus being preferable. A phosphonium salt according to the present invention includes at least one alkoxyalkyl group and has a significantly low viscosity compared with a quaternary phosphonium salt including alkyl groups only. Although the reason for this is not entirely clear at this point, it is believed that the electron-donating property of the alkoxy group decreases the cation charge.

In a quaternary phosphonium salt represented by general formula (1) according to the present invention, if the water content is 100 ppm or less, and preferably 50 ppm or less, a reaction reagent whose activity is decreased by water can be used without deactivation, which is preferable. Note that the water content can be determined by a Karl Fischer titration method.

As a quaternary phosphonium salt represented by general formula (1) wherein the anion component is a halogen, a commercially available quaternary phosphonium halide or a quaternary phosphonium halide obtained by allowing a trialkylphosphine to react with an alkoxyalkyl halide can be used. A quaternary phosphonium salt represented by general formula (1) wherein the anion component is any one other than a halide, can be obtained by allowing a quaternary phosphonium halide to react with a metal salt of the anion component to perform anion exchange. The term “quaternary phosphonium halide” refers to a quaternary phosphonium in which the cation moiety is a halogen.

For example, in the case where a quaternary phosphonium halide is produced by reaction of a trialkylphosphine with an alkoxyalkyl halide as described above, preferably, a trialkylphosphine (general formula: (R₁)₃P) is allowed to react with an alkoxyalkyl halide (general formula: X—(CH₂)ₙO—R₅), namely, R₁ to R₃ being the same alkyl group, R₄ being an alkoxyalkyl group, because it is possible to obtain the target compound containing a small amount of impurities.

Furthermore, in the case where an ionic liquid in which the anion component is any one other than a halogen is produced by anion exchange with a corresponding metal salt, preferably, the halogen of the quaternary phosphonium halide is bromine or iodine from the standpoint that reactivity with the metal salt of the anion component can be enhanced. Furthermore, when the halogen of the quaternary phosphonium halide is bromine or iodine, purification can be performed by recrystallization. Consequently, it is preferable to use an alkoxyalkyl bromide or an alkoxyalkyl iodide as the alkoxyalkyl halide. Furthermore, even in the case of a quaternary phosphonium chloride or the like, substitution of the other halogen element can be performed using sodium iodide or the like.

The reaction is carried out as follows. The alkoxyalkyl halide is added in an amount of 0.5 to 2 molar times, preferably 0.9 to 1.2 molar times, the amount of the trialkylphosphine, and reaction is allowed to proceed in an inert solvent, such as toluene, that does not contain chlorine, at 20° C. to 150° C., preferably at 30° C. to 100° C., for 3 hours or more, preferably for 5 to 12 hours.

The reaction atmosphere is not particularly limited as long as oxygen is not present. A nitrogen atmosphere or argon atmosphere is preferable. If the trialkylphosphine is allowed to react with the alkoxyalkyl halide under an atmosphere where oxygen is present, a trialkylphosphine oxide may be formed in which oxygen bonds to the trialkylphosphine, resulting in a decrease in yield, which is undesirable. The trialkylphosphine oxide can be removed by appropriately washing with an organic solvent. However, as the total number of carbon atoms in the quaternary phosphonium halide increases, the quaternary phosphonium halide tends to be dissolved in the organic solvent, and thus removal becomes difficult. Therefore, the reaction is preferably carried out under an inert atmosphere so as to prevent the formation of a trialkylphosphine oxide.

As the metal salt of the anion component that can be used for introducing other anions by anion exchange from the quaternary phosphonium, alkali metal salts, such as lithium salts, of the anion components described above can be used. When an alkali metal salt is used, the alkali halide generated from the reaction with the alkylphosphine halide can be easily removed by water washing, which is preferable.

As the water used for the water washing, ultrapure water or deionized water can be used. Preferably, the water washing is repeatedly and appropriately performed until the impurity content decreases. Examples of the impurities to be removed by water washing include unreacted starting materials, alkali halides, and the like.

Furthermore, in order to remove unreacted starting materials, by-products, and the like, washing with an organic solvent may be appropriately performed. As the organic solvent that can be used for washing, a nonpolar solvent, such as pentane, hexane, or heptane, which does not contain chlorine, is preferable because nonpolar organic compounds, such as impurities, can be efficiently removed without dissolving the quaternary phosphonium salt.

The quaternary phosphonium salt which has been washed with water or an organic solvent is preferably purified to remove water or the organic solvent. If the water content is 100 ppm or less, and preferably 50 ppm or less, a reaction reagent whose activity is decreased by water can be used without deactivation, thus being preferable. Examples of the method for purification include dehydration with a molecular sieve and solvent removal by vacuum drying. From the standpoints that entry of impurities can be prevented and water and the organic solvent can be removed at one time, purification by vacuum drying is preferable.

The purification by vacuum drying is performed at a drying temperature of 70° C. to 120° C., preferably 80° C. to 100° C., at a vacuum of 0.1 to 0.7 kPa, preferably 0.1 to 0.5 kPa, for 2 to 12 hours, preferably about 3 to 10 hours.

The ionic liquid including a quaternary phosphonium salt represented by general formula (1) has properties, such as low viscosity, moderate solubility, chemical stability, and thermal stability, which are derived from alkoxy, and thus can be used as a solvent for various reactions. In the case of low viscosity, diffusion and convection of a reactive substrate are accelerated, and reaction efficiency is significantly improved. In addition, since the rate of the increase in viscosity due to cooling is low, the ionic liquid can be used at low temperatures, thus being advantageous from the standpoint of reaction control. Furthermore, when the alkoxy group is introduced, the solubility of organic compounds tends to increase. That is, the introduction of the alkoxy group can solve the problem that, while the molecular weight can be decreased and an ionic liquid having a low viscosity can be obtained by decreasing the length of the alkyl group, the solubility of organic compounds is decreased by the decrease in the length of the alkyl group.

Furthermore, the ionic liquid including a phosphonium salt of according to the present invention has high chemical stability and high heat resistance and is stable to removal of the solvent by distillation under heating. Consequently, the ionic liquid is also advantageous as a reusable sustainable reaction solvent.

Furthermore, the ionic liquid including a phosphonium salt according to the present invention has a large range of choices of extracting solvents compared with a phosphonium salt having a large alkyl group. Since an ionic liquid including the phosphonium salt having a large alkyl group dissolves in most organic solvents other than hydrocarbons, in many cases, only a hydrocarbon, such as hexane, can be used as an extracting solvent. On the other hand, in the ionic liquid including a quaternary phosphonium salt according to the present invention, the alkyl group is moderately short, and the ionic liquid does not dissolve in water or an organic solvent, such as diethyl ether, toluene, pentane, hexane, or heptane. Consequently, such an organic solvent can be used as an extracting solvent. For example, when diethyl ether and water are added to the ionic liquid of the present invention, three layers, i.e., a diethyl ether layer, an aqueous layer, and an ionic liquid layer, are formed. The target product is extracted by the diethyl ether layer, and the ionic liquid layer can be recovered. Therefore, the ionic liquid including a phosphonium salt according to the present invention is not only excellent as a reaction solvent but also is reusable and environmentally friendly.

A case where the ionic liquid including a phosphonium salt according to the present invention is used as a solvent for a Grignard reaction will be described below.

As is well known, the Grignard reaction is a reaction between an organomagnesium halide, which is referred to as a Grignard reagent, and any of various organic compounds, and plays a very important role in organic synthesis reactions. Since the Grignard reagent is stabilized by coordination of ether oxygen, it is obtained by reaction between an alkyl halide and metallic magnesium in an ether solvent, such as diethyl ether or tetrahydrofuran. In this process, if water is present in the system, the Grignard reagent loses its activity due to the water. Consequently, it is necessary to use a dehydrated solvent and to carry out the reaction under an inert gas atmosphere, such as nitrogen or argon. Furthermore, the Grignard reagent has strong basicity, and therefore, if acid protons are present, the Grignard reagent rapidly reacts with the acid protons to form a hydrocarbon. Because of such a property, the Grignard reagent loses its activity in an imidazolium salt ionic liquid or ammonium salt ionic liquid which has acid protons. Thus, it has been believed that it is not possible to carry out a Grignard reaction in an ionic liquid.

On the other hand, when the ionic liquid including a phosphonium salt according to the present invention was evaluated by proton NMR, it was observed that the chemical shift of the hydrogen atom adjacent to the phosphonium cation was largely shifted by about 1 ppm to the high magnetic field side compared with that of the corresponding ammonium cation. As a result, it was found that the acidity of the hydrogen atom adjacent to the phosphonium cation was significantly low compared with that of the hydrogen atom adjacent to the ammonium cation. That is, it was found that the ionic liquid including a phosphonium salt according to the present invention was not easily attacked by a highly basic reagent, such as a Grignard reagent. Furthermore, as described above, the ether oxygen of the alkoxy group present in the ionic liquid including a phosphonium salt according to the present invention contributes to the stabilization of a Grignard reagent.

In addition to the properties described above, the ionic liquid including a phosphonium salt according to the present invention is characterized by significantly low viscosity. As described above, in the case of low viscosity, reaction efficiency improves in view of diffusion and convection of a reactive substrate, and also, since the rate of the increase in viscosity due to cooling is low, a Grignard reaction can be carried out at low temperatures, thus being advantageous from the standpoint of reaction control. Furthermore, as described above, low viscosity is advantageous from the standpoints of dehydration efficiency and removal of impurities by washing.

Furthermore, the ionic liquid including a phosphonium salt according to the present invention is highly heat-resistant and stable to removal of the solvent by distillation under heating, and thus is also advantageous as a reusable sustainable reaction solvent. As is clear from the properties described above, the ionic liquid including a phosphonium salt according to the present invention has low viscosity and significantly low reactivity with Grignard reagents, and can be used for Grignard reactions.

### EXAMPLES

The present invention will be described in more detail below on the basis of examples. However, it is to be understood that the examples are illustrative purposes only and the present invention is not limited thereto.

Synthesis of Ionic Liquids

### Example 1

### Synthesis of triethyl(2-methoxyethyl)phosphonium bis(trifluoromethylsulfonyl)imide (P222(201)-TFSI) and Measurement of Physical Properties Thereof

To 236 g (0.5 mol) of a 25% toluene solution of triethylphosphine (HISHICOLIN P-2 manufactured by Nippon Chemical Industrial Co., Ltd.), 70 g (0.5 mol) of 2-bromoethyl methyl ether (reagent manufactured by Tokyo Chemical Industry Co., Ltd.) was added dropwise, and reaction was allowed to proceed at 70° C. to 80° C. for 6 hours. After the reaction was completed, hexane was added to the reaction mixture and crystallization was performed. Thereby, 100 g of crystals of triethyl(2-methoxyethyl)phosphonium bromide was obtained (yield 74%). To 77 g (0.3 mol) of the resulting triethyl(2-methoxyethyl)phosphonium bromide, 86 g (0.3 mol) of lithium bis(trifluoromethylsulfonyl)imide (reagent manufactured by Kanto Chemical Co., Inc.) was added, and reaction was carried out in an aqueous system. The reaction mixture was aged while stirring at room temperature for 3 hours. After the stirring was completed, the lower layer (product) was isolated. Washing with pure water was carried out four times, and subsequently, washing with hexane was carried out four times. After the washing was completed, vacuum drying was performed at 100° C., at a vacuum of 0.5 kPa, for 5 hours (residual water content 100 ppm or less). The synthesis was confirmed by ¹H-NMR, ¹³C-NMR, ³¹P-NMR, and ¹⁹F-NMR. The amount of the product (colorless transparent liquid) yielded was 104 g (yield 76%). The purity was confirmed to be 98% or more by ³¹P-NMR.

Various Physical Properties Measured:

The melting point, which was measured by a differential scanning calorimeter (DSC6200, manufactured by Seiko Instruments Inc.), was 10° C. The viscosity, which was measured by an oscillation-type viscometer (VM-10A, manufactured by CBC Co., Ltd.), was 44 mPas (25° C.). Note that, depending on the measurement conditions, the measurement results of the viscosity may have a margin of error of about ±5%. The thermal decomposition temperature (10% weight loss), which was measured by a thermogravimetric analyzer (TG/DTA 6300, manufactured by Seiko Instruments Inc.), was 404° C. All of the measurements were performed under a nitrogen atmosphere. The water content, which was measured by a Karl Fischer aquameter (MKC-610, manufactured by Kyoto Electronics Manufacturing Co., Ltd.), was 19.5 ppm. Hereinafter, the measurements were conducted similarly.

### Example 2

### Synthesis of triethyl(methoxymethyl)phosphonium bis(trifluoromethylsulfonyl)imide (P222(101)-TFSI) and Measurement of Physical Properties Thereof

To 236 g (0.5 mol) of a 25% toluene solution of triethylphosphine (HISHICOLIN P-2 manufactured by Nippon Chemical Industrial Co., Ltd.), 62 g (0.5 mol) of bromomethyl methyl ether (reagent manufactured by Tokyo Chemical Industry Co., Ltd.) was added dropwise, and reaction was allowed to proceed at 70° C. to 80° C. for 6 hours. After the reaction was completed, hexane was added to the reaction mixture and crystallization was performed. Thereby, 97 g of crystals of triethyl(methoxymethyl)phosphonium bromide was obtained (yield 80%). To 73 g (0.3 mol) of the resulting triethyl(methoxymethyl)phosphonium bromide, 86 g (0.3 mol) of lithium bis(trifluoromethylsulfonyl)imide (reagent manufactured by Kanto Chemical Co., Inc.) was added, and reaction was carried out in an aqueous system. The reaction mixture was aged while stirring at room temperature for 3 hours. After the stirring was completed, the lower layer (product) was isolated. Washing with pure water was carried out four times, and subsequently, washing with hexane was carried out four times. After the washing was completed, vacuum drying was performed at 100° C., at a vacuum of 0.5 kPa, for 5 hours (residual water content 100 ppm or less). The synthesis was confirmed by ¹H-NMR, ¹³C-NMR, ³¹P-NMR, and ¹⁹F-NMR. The amount of the product (colorless transparent liquid) yielded was 104 g (yield 78%). The purity was confirmed to be 98% or more by ³¹P-NMR.

Various Physical Properties Measured:

Melting point: 14° C., viscosity: 39 mPas (25° C.), thermal decomposition temperature (10% weight loss): 388° C., and water content: 24.3 ppm.

### Example 3

### Synthesis of triethyl(methoxymethyl)phosphonium dicyanamide (P222(101)-DCA) and Measurement of Physical Properties Thereof

To 236 g (0.5 mol) of a 25% toluene solution of triethylphosphine (HISHICOLIN P-2 manufactured by Nippon Chemical Industrial Co., Ltd.), 62 g (0.5 mol) of bromomethyl methyl ether (reagent manufactured by Tokyo Chemical Industry Co., Ltd.) was added dropwise, and reaction was allowed to proceed at 70° C. to 80° C. for 6 hours. After the reaction was completed, hexane was added to the reaction mixture and crystallization was performed. Thereby, 97 g of crystals of triethyl(methoxymethyl)phosphonium bromide was obtained (yield 80%). To 73 g (0.3 mol) of the resulting triethyl(methoxymethyl)phosphonium bromide, 27 g (0.3 mol) of sodium dicyanamide (reagent manufactured by Wako Pure Chemical Industries, Ltd.) was added, and reaction was carried out in an aqueous system. The reaction mixture was aged while stirring at room temperature for 3 hours. After the stirring was completed, the product was extracted with dichloromethane and purified through a silica gel column. Then, the solvent was removed by distillation, and vacuum drying was performed at 100° C., at a vacuum of 0.5 kPa, for 5 hours (residual water content 100 ppm or less). The synthesis was confirmed by ¹H-NMR, ¹³C-NMR, and ³¹P-NMR. The amount of the product (pale yellow transparent liquid) yielded was 34 g (yield 50%). The purity was confirmed to be 98% or more by ³¹P-NMR.

Various Physical Properties Measured:

Viscosity: 32 mPas (25° C.), and water content: 97.8 ppm.

The various physical properties are summarized in Table 1 below. Furthermore, with respect to commercially available N,N-diethyl-N-methyl(2-methoxyethyl)ammonium bis(trifluoromethylsulfonyl)imide (DEME-TFSI), as an ammonium salt, the water content was measured by a Karl Fischer aquameter, and the melting point, the thermal decomposition temperature, and the viscosity were cited from the document (T. Sato, et al., Electrochim. Acta, 49 3603(2004)). These values are also shown in Table 1.

TABLE 1

| | | Thermal | | |
|---|---|---|---|---|
| | Melting | decomposition | | Water |
| | point | temperature | Viscosity | content |
| Ionic liquid | (° C.) | (° C.) | (mPas) | (ppm) |
| P222(101)-TFSI | 14 | 388 | 39 (25° C.) | 19.5 |
| P222(201)-TFSI | 10 | 404 | 44 (25° C.) | 24.3 |
| P222(101)-DCA | — | — | 32 (25° C.) | 97.8 |
| DEME-TFSI | <−50 | 383 | 120 (20° C.) | 129 |

### Example 4

Grignard Reaction

Under a dry nitrogen atmosphere, 2.8 g (5 mmol) of a THF solution of phenylmagnesium bromide (reagent manufactured by Tokyo Chemical Industry Co., Ltd.) was added to 15 ml of an ionic liquid P222(201)-TFSI cooled to 0° C., followed by stirring. To the resulting solution, 0.4 g (5 mmol) of dehydrated N,N′-dimethylformamide (reagent manufactured by Kanto Chemical Co., Inc.) was added dropwise for 10 minutes, followed by aging at 0±3° C. for 3 hours. After the aging was completed, 15 ml of an aqueous solution of saturated ammonium chloride was added to the mixture, followed by quenching. Then, 30 ml of n-hexane was added thereto, and the mixture was stirred for 30 minutes to extract the product. After the stirring was completed, the n-hexane layer was isolated, and 30 ml of n-hexane was added to the aqueous layer and the ionic liquid layer to repeat extraction. The n-hexane layer having the extracted target compound was colorless and transparent. The isolated n-hexane layers were combined and dehydrated over anhydrous sodium sulfate, and n-hexane was removed by distillation under reduced pressure at 50° C. and 10 kPa to yield the product. The resulting product was confirmed by ¹H-NMR and ¹³C-NMR to be benzaldehyde. The yield of benzaldehyde was 62%.

### Comparative Example 1

Benzaldehyde was obtained as in Example 4 except that DEME-TFSI (reagent manufactured by Kanto Chemical Co., Inc.) was used, instead of P222(201)-TFSI, as the ionic liquid. Extraction and dehydration were performed in the same manner. The yield of the resulting benzaldehyde was 43%. Note that the n-hexane layer having the extracted target compound was yellow-colored.

1. An ionic liquid comprising a quaternary phosphonium salt represented by general formula (1): 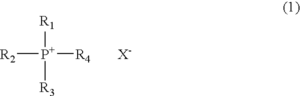
wherein R₁, R₂, R₃, and R₄ each represent a linear alkyl group having 1 to 6 carbon atoms, a branched alkyl group having 3 to 6 carbon atoms, an alicyclic alkyl group having 3 to 6 carbon atoms, or an alkoxyalkyl group represented by —(CH₂)ₙO—R₅ (wherein n is an integer of 1 to 6; and R₅ represents a methyl group or an ethyl group); at least one of R₁, R₂, R₃, and R₄ is an alkoxyalkyl group; R₁, R₂, R₃, and R₄ may be the same or different; R₁ and R₂ together may form a ring; and X represents an anion.

2. The ionic liquid according to claim 1, wherein the quaternary phosphonium salt represented by general formula (1) has a viscosity of 300 mPas or less.

3. The ionic liquid according to claim 1, wherein, in general formula (1), the number of carbon atoms of each of R₁, R₂, and R₃ is 2, and R₄ is a 2-methoxyethyl group.

4. The ionic liquid according to claim 1, wherein, in general formula (1), X is a bis(trifluoromethylsulfonyl)imide anion.

5. The ionic liquid according to claim 1, wherein the quaternary phosphonium salt represented by general formula (1) has a water content of 100 ppm or less.

6. A reaction solvent comprising the ionic liquid according to claim 1.

7. A reaction solvent for a Grignard reaction, comprising the ionic liquid according to claim 1.

8. The ionic liquid according to claim 2, wherein, in general formula (1), the number of carbon atoms of each of R₁, R₂, and R₃ is 2, and R₄ is a 2-methoxyethyl group.

9. The ionic liquid according to claim 2, wherein, in general formula (1), X is a bis(trifluoromethylsulfonyl)imide anion.

10. The ionic liquid according to claim 3, wherein, in general formula (1), X is a bis(trifluoromethylsulfonyl)imide anion.

11. The ionic liquid according to claim 2, wherein the quaternary phosphonium salt represented by general formula (1) has a water content of 100 ppm or less.

12. The ionic liquid according to claim 3, wherein the quaternary phosphonium salt represented by general formula (1) has a water content of 100 ppm or less.

13. The ionic liquid according to claim 4, wherein the quaternary phosphonium salt represented by general formula (1) has a water content of 100 ppm or less.

14. A reaction solvent comprising the ionic liquid according to claim 2.

15. A reaction solvent comprising the ionic liquid according to claim 3.

16. A reaction solvent comprising the ionic liquid according to claim 4.

17. A reaction solvent comprising the ionic liquid according to claim 5.

18. A reaction solvent for a Grignard reaction, comprising the ionic liquid according to claim 2.

19. A reaction solvent for a Grignard reaction, comprising the ionic liquid according to claim 3.

20. A reaction solvent for a Grignard reaction, comprising the ionic liquid according to claim 4.
